(19) United States
(12) Patent Application Publication
(10) Pub. No.: US 2008/0249988 A1
(43) Pub. Date: Oct. 9, 2008

(54) COMPUTER PROGRAMMING METHOD AND SYSTEM FOR PERFORMING A REVERSAL OF SELECTED STRUCTURED QUERY LANGUAGE OPERATIONS WITHIN A DATABASE TRANSACTION

(75) Inventors: Krishna R. Chaitanya, Tamil Nadu (IN); Anithra Priyadarshini Janakiraman, Tamil Nadu (IN)

Correspondence Address: LEE LAW, PLLC;IBM CUSTOMER NUMBER, P.O. BOX 189, PITTSBORO, NC, 27312, US

(73) Assignee: INTERNATIONAL BUSINESS MACHINES CORPORATION, Armonk, NY (US)

(21) Appl. No.: 11/697,673

(22) Filed: Apr. 6, 2007

(51) Int. Cl. G06F 17/30

(52) U.S. Cl. 707/3

(57) ABSTRACT

An invention is disclosed for performing reversal of selected Structured Query Language (SQL) operations within a database transaction by a database server. Specifically, a computer programming product, method and system is provided for enabling a software client to reverse (i.e., “undo” or “rollback”) one or more selected SQL statement(s) within the current transaction without having to reverse the entire database transaction.

### TECHNICAL FIELD

This invention relates to a method for performing reversal of Structured Query Language (SQL) operations within a database transaction.

### BACKGROUND

Relational database structured query language (SQL) ROLLBACK statements act on the transaction or logical unit of work (LUW) level to reverse (or “undo”) all of the SQL statements that constitute the database transaction when existing computer programming methods are used. The ROLLBACK statement in SQL reverses the changes made by the current database transaction and is typically used to cancel the entire transaction, i.e., the transaction can be “rolled back” completely by specifying the ROLLBACK statement. The alternative to “rolling back” a transaction is to utilize the COMMIT command to make the proposed changes part of the relational database. However, use of COMMIT and ROLLBACK statements should be minimized due to the amount of processing time and/or resources they require for completion.

Current solutions can only perform a “rollback” of an entire transaction or a “rollback” of operations up to a specified savepoint in the log, and thus do not address the problem solved by this invention. There is currently no programming method where any single SQL statement in a LUW can be reversed (or “undone”) without the using software program client having to perform a reversal of all the SQL statements executed to that point in the transaction. This invention enables a client to reverse (or “undo”) one or more (but less than all) selected structured query language (SQL) statement(s) within a single logical unit of work (LUW) database transaction. The invention therefore minimizes the number of COMMIT and/or ROLLBACK statements needed to selectively reverse (or “undo”) portion(s) of a database transaction, and thus provides a tool for the software developer to permit creation of robust applications that allow increased flexibility when programming a database application.

### SUMMARY OF THE INVENTION

An invention is disclosed for performing a reversal of selected Structured Query Language (SQL) operation(s) within a database transaction. Specifically, a computer programming product, method and system is provided for enabling a using software client to reverse (i.e., “undo” or “rollback”) one or more selected SQL statement(s) within a database transaction. This invention provides the client with an SQL statement UNDO (n) which allows a database server to reverse only those specific SQL operation(s) in a transaction that are defined by the parameter (n) “host variable(s)” without having to reverse the entire database transaction.

It is therefore an object of the present invention to perform a reversal of selected Structured Query Language (SQL) operation(s) within a database transaction.

It is another object of the present invention to provide a computer programming product, method and system for enabling a using software client to reverse (i.e., “undo” or “rollback”) one or more selected SQL statement(s) within a logical unit of work (LUW) database transaction.

It is another object of the present invention to provide the client with an SQL UNDO statement which allows a database server to reverse only those specific SQL operation(s) in a database transaction that are defined by the operative “host variable(s)”.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DETAILED DRAWINGS

FIG. 1 is a flowchart illustrating the operation of a using program client of the present invention.

FIG. 2 is a flowchart illustrating the operation of a database server of the present invention.

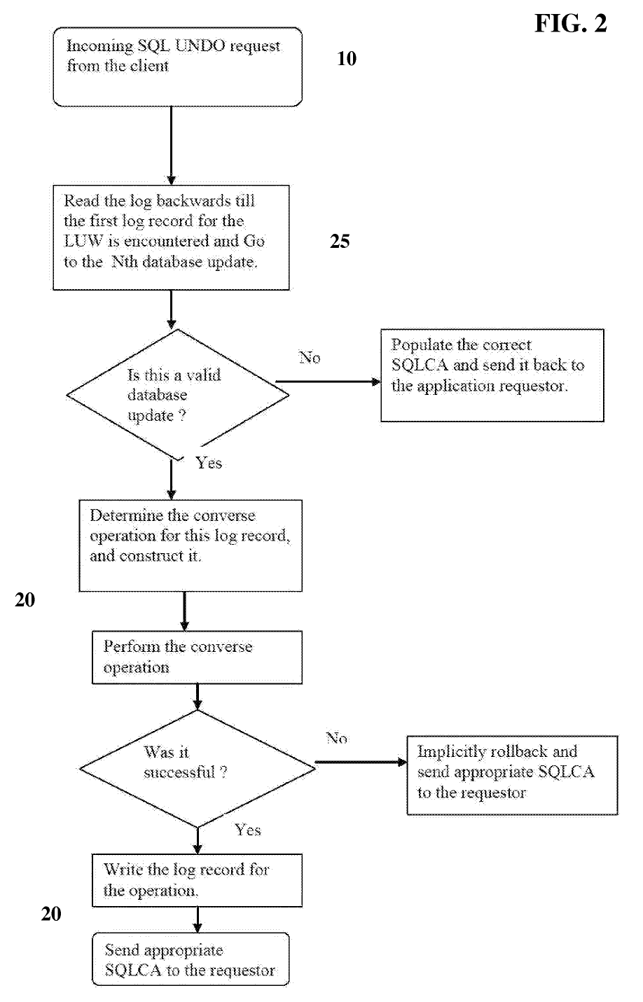

### DETAILED DESCRIPTION OF THE PREFERRED EMBODIMENTS

To illustrate how the invention can be used to solve this problem, consider the following prior art example where a using software application performs the following operations on an SQL relational database included as part of a computer system:

EXEC SQL CONNECT TO DATABASE 1
INSERT INTO TABLE 1
INSERT INTO TABLE 2
INSERT INTO TABLE 3
....
INSERT INTO TABLE 50 --- > incorrect data entered
UPDATE TABLE 1
UPDATE TABLE 2
UPDATE TABLE 3
....
UPDATE TABLE 25 --- > incorrect data entered
....
UPDATE TABLE 49 --- > incorrect data entered
....
UPDATE TABLE 50 --- > statement fails with negative
SQLCODE due to incorrect inputs

In the event that UPDATE TABLE 50 fails with a negative SQL code, then the using client must UNDO the following SQL statements in order to consistently maintain the logic used to construct and operate the database:

#50. INSERT INTO TABLE 50
#75. UPDATE TABLE 25
#99. UPDATE TABLE 49

With existing prior art programming techniques, the client must issue a ROLLBACK statement in order to reverse (or “undo”) all fifty database INSERT(s) and UPDATE(s) that were previously performed unless more COMMIT statements are issued, since there is no current programming mechanism that allows only the foregoing three SQL statements to be specifically reversed and re-executed. Now with a preferred implementation of the invention, if UPDATE TABLE 50 fails then instead of performing a ROLLBACK operation of all the previously-executed SQL statements, the following SQL UNDO (n) statements can be executed by the client in order to “undo” the erroneous statements:

UNDO (50)
UNDO (75)
UNDO (99)

and the client can then “redo” only the incorrect operations:

INSERT INTO TABLE 50
UPDATE TABLE 25
UPDATE TABLE 49

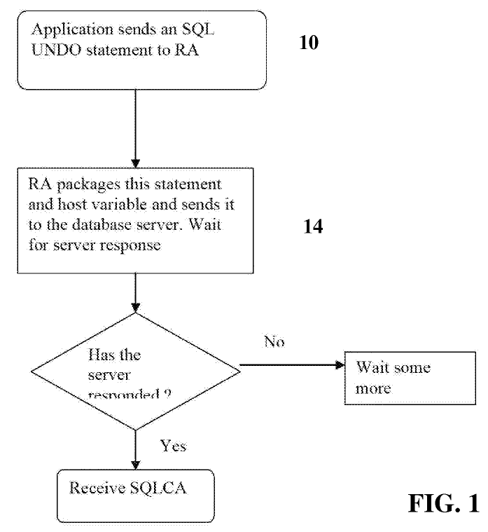

As illustrated in a preferred embodiment of FIGS. 1 & 2, the SQL preprocessor (PREP) 12 examines (i.e., “parses” or “traverses”) the SQL UNDO (n) instruction statement issued by the using client program 10, and the preprocessor 12 populates an internal data structure sent to the resource adapter program (RA) 14 so that it recognizes the request as an UNDO instruction. The resource adapter 14 receives the request and convert the UNDO statement into a suitable format so that the instruction/data stream sent to the database server 20 will accommodate the operative “host” variable(s) (n) in the SQL UNDO statement to be executed. This conversion can be accomplished with distributed relational data architecture (DRDA) or with the private protocol implemented by the particular database program in use (such as DB2). The database server 20 receives the UNDO instruction and decodes it by processing it in the same manner as any other received instruction/data stream. When the database server 20 recognizes a statement as an SQL UNDO (n) request, it traverses the database instruction execution record log 25 (preferably) “backwards” (i.e., from most to least recently-executed SQL statement) until the first log record for the current LUW is encountered and then locates the selected (n) statement(s) to be reversed. When an SQL UNDO statement is issued before any other database update has occurred in a LUW, the database server will return an SQL code to the using application program indicating that there is no SQL operation to “undo” yet.

To implement these features in a preferred embodiment of the invention, the SQL preprocessor (PREP) 12 must (a) correctly parse the SQL UNDO statement requested by the using client program 10; and (b) correctly populate the RDIIN (or other data structure) passed to the resource adapter 14 so that the request is recognized as an UNDO statement. The resource adapter (RA) 14 must (a) receive the SQL UNDO request from the executing client program 10; (b) convert the UNDO statement into a suitable format for processing by the database server 20; and (c) send the UNDO statement to the database server 20 and receive the response from the server indicating the outcome of its execution. The database server 20 must (a) understand the SQL UNDO request sent to it by the resource adapter 14; (b) read the database instruction execution log 25 to locate the operation in the current logical unit of work (LUW) that is specified by the “host variable” number “n” identified in each UNDO (n) statement; (c) perform a reversal of the identified transaction; and (d) send a response indicating the outcome of execution of the UNDO statement back to the client 10 (optionally) via the resource adapter 14. The version of Structured Query Language (SQL) used in programming the invention must preferably include a standardized definition for the UNDO (n) statement and SQLCODE(s) must be allocated to signify the following error conditions: (a) issuance of the UNDO statement before any other database update is executed in the current LUW; (b) an indication that the operation performed by the UNDO statement was unsuccessful.

The following program chart illustrates a sample database instruction execution log header 25. Upon receipt of an UNDO (n) request, the database server 20 decodes (or “reads”) the “previous record” (PREVREC) field and traverses the log 25 backwards until the value for PREVREC is set to “null” (signifying the first record in the current LUW). Since the length of each database record can be calculated in its number of bytes, the server 20 then passes over (or skips”) (n) records in the log until it reaches the subject nth SQL statement to be reversed, counting only modifications to data (i.e., INSERT/UPDATE/DELETE operations) as eligible for being “skipped”. The database server 20 then reads the subject nth log record for the LUW to construct a corresponding converse SQL statement that reinstates the data existing in the database record prior to execution of the nth selected SQL operation being “undone” (in a manner similar to execution of an SQL ROLLBACK statement). After construction of the converse operation, the database server 20 performs this operation on the database and writes only the converse record on the log 25 by using appropriate “Before” and “After” “images” of the data to construct it.

| Offset | Name | Description |
|---|---|---|
| 0(0) | LOGHEAD | BASED NOTE: RECTYPE |
| | | MUST BE THE 1st FIELD |
| 0(0) | RECTYPE | TYPE OF LOG RECORD |
| 1(1) | RECLTH | LENGTH OF DATA PART |
| | | (FOLLOWS HDR) |
| 4(4) | TRANS | LUW IDENTIFIER |
| 8(8) | PREVREC | RELATIVE ADDRESS IN |
| | | LOG OF THE PREV LOG |
| | | RECORD OF THIS LUW |
| 12(C) | TIMESTMP | TOD WHEN RECORD |
| | | WAS STARTED |

When a using client 10 issues an SQL UNDO (n) statement and the nth record in the database transaction log 25 for the LUW is an INSERT operation, the converse operation (a DELETE statement) is constructed by reversing the “Before” and “After” image of the INSERT operation. The converse DELETE record will then be written to the log after execution of the constructed DELETE operation. Below is an example INSERT log and the corresponding DELETE log written after execution of the UNDO statement.

| | | | Converse DELETE | | |
|---|---|---|---|---|---|
| INSERT LOG RECORD | | | RECORD written after UNDO | | |
| Offset | Name | Description | Offset | Name | Description |
| 0(0) | LINSERT | BASED LOGDATA | 0(0) | LDELETE | BASED LOGDATA |
| | | FOR INSERT | | | FOR DELETE |
| 0(0) | LINSHEAD | HEADER OF | 0(0) | LDELHEAD | HEADER OF |
| | | LOGGED DATA | | | LOGGED DATA |
| 1(1) | LINSSEG | SEGMENTED ID | 1(1) | LDELSEG(=LINSSEG) | SEGMENTED ID |
| | | INSERTED TUPLE | | | DELETED TUPLE |
| 3(3) | LINSTID | TID OF INSERTED | 3(3) | LDELTIDB(=LINSTID) | BASE TID OF |
| | | TUPLE | | | DELETED TUPLE |
| 7(7) | LINSRID | RID INSERTED | 7(7) | LDELRID(=LINSRID) | RID DELETED |
| | | TUPLE | | | TUPLE |
| 9(9) | LINSLTH | TOTAL LENGTH | 9(9) | LDELLTH(=LINSLTH) | TOTAL LENGTH |
| | | OF TUPLE | | | OF TUPLE |
| 43(2B) | LINSVAL | FIELD VALUES | 43(2B) | LDELVAL(=LINSVAL) | FIELD VALUES |
| | | INSERTED TUPLE | | | DELETED TUPLE |

When a using client 10 issues an SQL UNDO (n) statement and the nth record in the database transaction log 25 for the LUW is a DELETE operation, the converse operation (an INSERT statement) is constructed by reversing the “Before” and “After” database image of the DELETE operation. The converse INSERT record will then be written to the log after execution of the constructed INSERT operation. Below is an example DELETE log and the corresponding INSERT log written after execution of the UNDO statement:

| | | | Converse INSERT | | |
|---|---|---|---|---|---|
| DELETE LOG RECORD | | | RECORD written after UNDO | | |
| Offset | Name | Description | Offset | Name | Description |
| 0(0) | LDELETE | BASED LOGDATA | 0(0) | LINSERT | BASED LOGDATA |
| | | FOR DELETE | | | FOR INSERT |
| 0(0) | LDELHEAD | HEADER OF | 0(0) | LINSHEAD | HEADER OF |
| | | LOGGED DATA | | | LOGGED DATA |
| 1(1) | LDELSEG | SEGMENTED ID | 1(1) | LINSSEG(=LDELSEG) | SEGMENTED ID |
| | | DELETED TUPLE | | | INSERTED TUPLE |
| 3(3) | LDELTIDB | BASE TID OF | 3(3) | LINSTID(=LDELTIDB) | TID OF |
| | | DELETED TUPLE | | | INSERTED TUPLE |
| 7(7) | LDELRID | RID DELETED | 7(7) | LINSRID(=LDELRID) | RID INSERTED |
| | | TUPLE | | | TUPLE |
| 9(9) | LDELLTH | TOTAL LENGTH | 9(9) | LINSLTH(=LDELLTH) | TOTAL LENGTH |
| | | OF TUPLE | | | OF TUPLE |
| 43(2B) | LDELVAL | FIELD VALUES | 43(2B) | LINSVAL(=LDELVAL) | FIELD VALUES |
| | | DELETED TUPLE | | | INSERTED TUPLE |

When a using client 10 issues an SQL UNDO (n) statement and the nth record in the database transaction log 25 for the LUW is an UPDATE operation where the log contains a full “Before” database image and a partial “After” database image for the UPDATE operation, the converse operation will be another UPDATE statement. For the converse UPDATE operation, the complete “Before” image is constructed using the partial “After” image, while the partial “After” image is built using a portion (i.e., the modified part) of the “Before” image. A new UPDATE record is then written to the log after execution of the constructed UPDATE statement. Below is an example UPDATE log and the corresponding converse UPDATE log created after execution of the UNDO statement. (The field names of the original record are in small letters and the converse record in capitals.)

| | | | Converse UPDATE | | |
|---|---|---|---|---|---|
| UPDATE LOG RECORD | | | RECORD written after UNDO | | |
| Offset | Name | Description | Offset | Name | Description |
| 0(0) | lupdate | BASED LOGDATA | 0(0) | LUPDATE | BASED LOGDATA |
| | | FOR UPDATE | | | FOR UPDATE |
| 0(0) | lupdhead | HEADER OF | 0(0) | LUPDHEAD | HEADER OF |
| | | LOGGED DATA | | | LOGGED DATA |
| 1(1) | lupdseg | SEGMENTED ID | 1(1) | LUPDSEG(=lupdseg) | SEGMENTED ID |
| | | UPDATED TUPLE | | | UPDATED TUPLE |
| 3(3) | lupdtid | TID OF UPDATED | 3(3) | LUPDTID(=lupdtid) | TID OF UPDATED |
| | | TUPLE | | | TUPLE |
| 7(7) | lupdrid | RID OF UPDATED | 7(7) | LUPDRID(=lupdrid) | RID OF UPDATED |
| | | TUPLE | | | TUPLE |
| 17(11) | lupdlth1 | LENGTH OF OLD | 17(11) | LUPDLTH1(=lupdlth2) | LENGTH OF |
| | | SUBTUPLE | | | OLD SUBTUPLE |
| 19(13) | lupdlth2 | LENGTH OF NEW | 19(13) | LUPDLTH2(=lupdlth1) | LENGTH |
| | | SUBTUPLE | | | OF NEW SUBTUPLE |
| 21(15) | lupdbeg | DISPLAY IN TUPLE | 21(15) | LUPDBEG(=lupdbeg) | DISPLAY IN |
| | | OF 1ST UPDATED | | | TUPLE OF 1^{ST} |
| | | BYTE | | | UPDATED BYTE |
| 24(18) | lupddoms | OLD TUPLE | 24(18) | LUPDDOMS | OLD TUPLE |
| | | NEW SUBTUPLE | | (calculated using | NEW SUBTUPLE |
| | | | | lupdlth1/lupdlth2/ | |
| | | | | lupdbeg/lupddoms) | |

In all cases, the LUW identifier for the new log record is the same as the LUW identifier of the operation for which the SQL UNDO statement was issued and no “rollback record” is written into the log after the SQL UNDO operation is performed; instead log records are written for each of the converse operations performed. When a COMMIT or ROLLBACK statement is executed, the UNDO statement is treated as one or more database updates and the semantics followed for INSERT/UPDATE/DELETE operations is preserved. The UNDO statement therefore behaves like an INSERT/UPDATE/DELETE statement executed as part of the database transaction and (unlike ROLLBACK and COMMIT statements) does not signify the end of the transaction. As a result, the UNDO operation ensures that the LUW remains atomic to guarantee the consistency and integrity of the database.

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A computer system for performing a reversal of selected Structured Query Language (SQL) operations within a database transaction and comprised of at least the following software components containing program instructions executed by the computer system for enabling a using software program to reverse one or more selected SQL statements within the database transaction:
(a). a using program client programmed to issue at least one SQL UNDO instruction each containing a host variable; and
(b). a database server programmed to receive and execute the issued UNDO instruction to locate and reverse the SQL statement defined by the host variable;
wherein the software components are programmed to reverse only those selected operations that are defined by a host variable.

2. The computer system of claim 1 wherein the database server is programmed to:
(a). read a recorded log of executed SQL statements for the database transaction to locate and select the operation(s) defined by the host variable identified in each UNDO instruction;
(b). perform a reversal of each selected operation by constructing and executing a converse SQL statement to reinstate the data existing in the database prior to execution of the selected operation;
(c). record the results of the converse operation in the log; and
(d). send a response indicating the outcome of execution of each UNDO instruction to the client.

3. The computer system of claim 2 wherein the database server is programmed to record the results of the converse operation without recording the UNDO instruction in the log

4. The computer system of claim 2 wherein a selected operation is an SQL INSERT statement and the converse operation is an SQL DELETE statement.

5. The computer system of claim 2 wherein a selected operation is an SQL DELETE statement and the converse operation is an SQL INSERT statement.

6. The computer system of claim 2 wherein a selected operation is an SQL UPDATE statement and the converse operation is another SQL UPDATE statement.

7. The computer system of claim 1 wherein the database server is programmed to signify the following error conditions:
(a). issuance of an UNDO instruction before any other operation is executed; and
(b). indication that an UNDO instruction was unsuccessfully executed.

8. The computer system of claim 1 wherein the number of SQL COMMIT or ROLLBACK statements are minimized within a using program.

9. The computer system of claim 1 wherein less than all SQL statements within a database transaction are reversed.

10. A method of programming a computer system for use in performing a reversal of selected Structured Query Language (SQL) operations within a database transaction and comprised of at least the following steps carried out by the following software components containing program instructions executed by the computer system for enabling a using software program to reverse one or more selected SQL statements within the database transaction:
(a). programming a using program client to issue at least one SQL UNDO instruction each containing a host variable; and
(b). programming a database server to receive and execute the issued UNDO instruction to locate and reverse the SQL statement defined by the host variable;
wherein the software components are programmed to reverse only those selected operations that are defined by a host variable.

11. The method of claim 10 wherein the database server is programmed to:
(a). read a recorded log of executed SQL statements for the database transaction to locate and select the operation(s) defined by the host variable identified in each UNDO instruction;
(b). perform a reversal of each selected operation by constructing and executing a converse SQL statement to reinstate the data existing in the database prior to execution of the selected operation;
(c). record the results of the converse operation in the log; and
(d). send a response indicating the outcome of execution of each UNDO instruction to the client.

12. The method of claim 111 wherein the database server is programmed to record the results of the converse operation without recording the UNDO instruction in the log.

13. The method of claim 111 wherein a selected operation is an SQL INSERT statement and the converse operation is an SQL DELETE statement.

14. The method of claim 111 wherein a selected operation is an SQL DELETE statement and the converse operation is an SQL INSERT statement.

15. The method of claim 111 wherein a selected operation is an SQL UPDATE statement and the converse operation is another SQL UPDATE statement.

16. The method of claim 10 wherein the database server is programmed to signify the following error conditions:
(a). issuance of an UNDO instruction before any other operation is executed; and
(b). indication that an UNDO instruction was unsuccessfully executed.

17. The method of claim 10 wherein the number of SQL COMMIT or ROLLBACK statements are minimized within a using program.

18. The method of claim 10 wherein less than all SQL statements within a database transaction are reversed.

19. A computer program product for use with a computer system for performing a reversal of selected Structured Query Language (SQL) operations within a database transaction and comprised of a computer readable storage medium containing program instructions executed by at least the following software components of the computer system for enabling a using software program to reverse one or more selected SQL statements within the database transaction:
(a). a using program client programmed to issue at least one SQL UNDO instruction each containing a host variable; and
(b). a database server programmed to receive and execute the issued UNDO instruction to locate and reverse the SQL statement defined by the host variable;
wherein the software components are programmed to reverse only those selected operations that are defined by a host variable.

20. The computer program product of claim 19 wherein the database server is programmed to:
(a). read a recorded log of executed SQL statements for the database transaction to locate and select the operation(s) defined by the host variable identified in each UNDO instruction;
(b). perform a reversal of each selected operation by constructing and executing a converse SQL statement to reinstate the data existing in the database prior to execution of the selected operation;
(c). record the results of the converse operation in the log; and
(d). send a response indicating the outcome of execution of each UNDO instruction to the client.
